(19) United States
(12) Patent Application Publication
(10) Pub. No.: US 2024/0236232 A1
(43) Pub. Date: Jul. 11, 2024

(54) COGNITIVE SELECTION OF TRUSTED CONTACT USING INTERNET OF THINGS (IOT) DATA

(71) Applicant: International Business Machines Corporation, Armonk, NY (US)

(72) Inventors: Radha Mohan De, Howrah (IN); Luigi Pichetti, Rome (IT); Cristina Bonanni, Rome (IT); Leonardo Rosati, Rome (IT)

(73) Assignee: International Business Machines Corporation, Armonk, NY (US)

(21) Appl. No.: 18/094,699

(22) Filed: Jan. 9, 2023

(51) Int. Cl. H04M 3/42

(52) U.S. Cl. CPC H04M 3/42093; H04M 3/42042; H04M 3/42068

(57) ABSTRACT

An embodiment includes generating, responsive to detecting a communication attempt made by a caller, first request data indicative of a first connection request from a caller communication terminal associated with the caller to a callee communication terminal associated with a callee. The embodiment appends caller context data to the first request data, where the caller context data is based on Internet of Things (IoT) data received from an IoT device associated with the caller. The embodiment detects a connection failure resulting from the connection request. The embodiment generates callee context data based on IoT data received from an IoT device associated with the callee, and then selects a trusted contact from among a list of trusted contacts associated with the callee and generates second request data indicative of a second connection request from the caller communication terminal to a contact communication terminal associated with the trusted contact.

### BACKGROUND

The present invention relates generally to management of communications. More particularly, the present invention relates to a method, system, and computer program for cognitive selection of a trusted contact using IoT data.

When a smartphone detects an incoming call, the smartphone typically presents a user (the callee) with an option to answer the call and an option to decline the call. A simple declining of the call does not provide any information to the caller regarding the callee's status or reason for not answering the call. For example, the caller may not know whether the callee declined the call because the callee is driving, attending a meeting, or simply does not want to pick up the call.

Many telephone systems offer a caller identification (caller ID) service that transmits a caller's telephone number to the callee's telephone equipment while a call is being set up. The caller ID service may include the transmission of a name associated with the calling telephone number, in a service called Calling Name Presentation (CNAM). If the caller's telephone number is stored with contact information in a smartphone under a certain name, many smartphones will display the contact's name with, or in place of, the telephone number.

### SUMMARY

The illustrative embodiments provide for cognitive selection of trusted contact using IoT data. An embodiment includes generating, responsive to detecting a communication attempt made by a caller, first request data indicative of a first connection request from a caller communication terminal associated with the caller to a callee communication terminal associated with a callee. The embodiment also includes appending caller context data to the first request data, where the caller context data is based at least in part on first Internet of Things (IoT) data received from a first IoT device associated with the caller. The embodiment also includes detecting a first connection failure resulting from the first connection request. The embodiment also includes generating callee context data based at least in part on second IoT data received from a second IoT device associated with the callee. The embodiment also includes selecting, responsive to detecting the first connection failure, a first trusted contact from among a list of trusted contacts associated with the callee, where the first trusted contact is selected based at least in part on the callee context data. The embodiment also includes generating second request data indicative of a second connection request from the caller communication terminal associated with the caller to a contact communication terminal associated with the first trusted contact. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example service infrastructure in accordance with an illustrative embodiment;

FIG. 3 depicts a block diagram of an example caller communication terminal in accordance with another illustrative embodiment;

FIG. 4 depicts a block diagram of an example processing environment in accordance with an illustrative embodiment;

FIG. 5 depicts a block diagram of an example processing environment in accordance with an illustrative embodiment;

FIG. 6 depicts a block diagram of an example cognitive call management module in accordance with an illustrative embodiment;

FIG. 7 depicts a block diagram of an example connection module in accordance with an illustrative embodiment;

FIG. 8 depicts a schematic diagram of an example of a map used to select a trusted contact in accordance with an illustrative embodiment;

FIG. 9 depicts a flowchart of an example process for automatic cognitive selection of a trusted contact using IoT data in accordance with an illustrative embodiment; and

FIG. 10 depicts a flowchart of an example process for automatically selecting a trusted contact in accordance with an illustrative embodiment.

### DETAILED DESCRIPTION

Despite the wide use of smartphones, various communication-related applications, and other communication-related technologies, situations still arise in which a callee may be unreachable in an urgent or important situation. For example, many people use caller ID information as a basis for deciding whether to answer an incoming call. If the caller's telephone number is not recognized, the callee may decide to decline or ignore the incoming call. However, this practice can be problematic in situations where an unknown caller is calling about an urgent or important situation.

Sometimes a caller who is not known or familiar to the callee may be able to send a text message to convey an urgent or important message when the callee does not answer a call. However, this option is not helpful or available in every situation. For example, if the callee is unreachable via a telephone call because the callee is distracted and not paying attention to their phone, or because the callee's phone is inoperable due to damage to the phone or a depleted battery, the callee will also be unreachable via a text message. Also, in some situations, the caller may be unfamiliar with the callee and may not know if the callee receives text messages at the particular phone number the caller is calling. Alternatively, the caller may be calling from a landline or business telephone that is not configured to send text messages.

The disclosed embodiments recognize that situations arise in which current communications devices lack any functionality that will provide an alternative way for a caller to reach a callee in an urgent situation when the callee does not answer their call. For example, a caller may be calling a callee about finding the callee's dog, but the callee may be ignoring the call since it is from an unfamiliar caller. As another example, a caller may be an emergency rescuer calling about a callee's relative involved in an emergency situation, and the callee may be busy at work and not paying attention to their phone or may ignore the call since it is not from a familiar phone number.

The disclosed embodiments address and provide a solution to this technical problem using an approach that introduces a communication call management module for a cognitive call management module (also referred to more simply as a call management module) that monitors a communication terminal for communication requests to other communication terminals. A communication request refers to a signal or data transmitted from a caller's communication terminal to a callee's communication terminal via the cognitive call management module as part of a call setup call management module. A communication terminal may be any electronic device capable of making and receiving telephone calls, such as a smartphone or mobile telephone, or a tablet computer, laptop computer, desktop computer, or other computing device configured to use an Internet Protocol (IP) enabled calling service, such as voice over IP (VoIP). In exemplary embodiments, when the call management module detects a communication request, the call management module supplements the communication request with caller context data. Caller context data refers to metadata about a caller that is appended to a communication request and includes information that may be helpful to a callee for determining the purpose of the call, the level of importance or urgency of the call, the legitimacy of the call or caller, and may include information that indicates a location of the caller, an activity of the caller, and may validate an identity of the caller or corroborate a reason for the call.

In exemplary embodiments, the call management module appends caller context data to a communication request such that information from the context data may be conveyed to the callee prior to the callee accepting the call. For example, in some embodiments, the call management module sends the context data as a text message (e.g., using a Short Messaging Service (SMS) or Multimedia Messaging Service (MMS)) to the callee's communication terminal in parallel with the communication request. In some embodiments, the call management module sends the context data through Session Initiation Protocol (SIP) header tokens during a STIR/SHAKEN (Secure Telephony Identity Revisited/Signature-based Handling of Asserted information using toKENs) call authentication call management module.

In exemplary embodiments, the call management module gathers information that may be useful as context data to a callee from available and authorized resources. In some such embodiments, the call management module accesses computing resources to gather, with the permission of the user, information about the user, including data relevant to a communication request initiated by the user. For example, social media platforms can provide data relevant to a user's location, current or recent activities, occupation, identity, and acquaintances. IoT devices can provide data relevant to a user's location and current or recent activities. Service provider platforms, which refer to web-based platforms provided by telephone service providers, provide data relevant to a user's call history.

In some embodiments, one or more caller IoT devices and one or more callee IoT devices may interact in a controlled social IoT network, based on bilateral agreements from owners of the IoT devices. In some embodiments, one or more caller IoT devices and one or more callee IoT devices may be permitted, for example based on confidentiality agreements, to share information about the owner's location, location history, and/or activities with the other owner's IoT devices. In some such embodiments, the call management module gathers information from the shared information that may be useful as context data to a callee.

In exemplary embodiments, the call management module determines if the communication request results in a call that is accepted by the callee or is declined or otherwise not accepted by the callee. In exemplary embodiments, if the call management module determines that the call is not completed (e.g., because the callee declined the call, the call was not answered by the callee, or the callee's communication terminal could not be contacted), the call management module provides the caller with one or more alternative options for trying to reach the callee. In some embodiments, if the call management module determines that the call is not completed, the call management module automatically commences with one or more alternative techniques for trying to reach the callee.

In exemplary embodiments, if the call management module determines that the call is not completed, the call management module attempts to select and contact a third party. In some embodiments, the call management module selects the third party based on a determination that the selected third party has a highest likelihood of being able to contact the callee. In some embodiments, the call management module makes this determination based on a trust factor and a probability factor.

In exemplary embodiments, the call management module establishes trust factor values for respective third parties based on whether the third parties are included in a list of trusted contacts for the callee. In exemplary embodiments, the call management module establishes probability factor values for respective third parties based on call history data indicative of past calls between the third party and the callee and/or past call attempts from the third party to the callee and/or spatiotemporal information indicative of a current or recent geographic distance between the third party and the callee.

In some embodiments, with the permission of the callee, the call management module automatically generates a list of trusted contacts for the callee over a period of time. In some embodiments, the call management module uses interaction history data to identify contacts that are trusted by the callee. In some embodiments, the call management module uses interaction history data indicative of past interactions between the callee and each of the third parties to identify third parties that are trusted by the callee.

In exemplary embodiments, the call management module accesses computing resources to gather, with the permission of the callee, information about the callee, including interaction history data indicative of past interactions between the callee and each of the third parties to identify third parties that are trusted by the callee. For example, social media platforms can provide interaction history data relevant to past social media interactions between the callee and each of the third parties. Service provider platforms, which refer to web-based platforms provided by telephone service providers, provide data relevant to a callee's call history with each of the third parties. In some embodiments, the call management module extracts or infers various types of information from the interaction history data, such as relationship information (e.g., familial relationship, business relationship, neighbor, acquaintance, etc.) between the callee and each of the third parties, call success rate (e.g., percentage of calls accepted by the callee) for each of the third parties, and/or a level of rapport between the callee and each of the third parties. interaction history data by accessing, with permission of the callee, a social media platform utilized by the callee. In exemplary embodiments, the cognitive call management module uses this information to identify callee contacts that appear to be trusted by the callee and adds these trusted contacts to a trusted contact list for the callee.

In exemplary embodiments, the call management module generates callee context data from callee IoT device(s). In some embodiments, the call management module uses the callee context data to select a trusted contact from list of the callee's trusted contacts. For example, in some embodiments, if the callee is unavailable or otherwise does not accept a call, the call management module selects a third party who may be able to pass along a message to the callee or inform the callee that the caller is urgently trying to contact them.

In some embodiments, one or more callee IoT devices and one or more contact IoT devices of one or more of the callee's trusted contacts may interact in a controlled social IoT network, based on bilateral agreements from owners of the IoT devices. In some embodiments, one or more callee IoT devices and one or more contact IoT devices of one or more trusted contacts may be permitted, for example based on confidentiality agreements, to share information about the owner's location, location history, and/or activities with the other owners' IoT devices. In some such embodiments, the call management module uses the shared information as callee context data to select a trusted contact from list of the callee's trusted contacts.

In some embodiments, the call management module may use information from these or other available and authorized resources to generate context data about the callee that the call management module may use to select a trusted contact of the callee. In some embodiments, the call management module then forwards the call or a message to the selected trusted contact. For example, in some embodiments, the call management module generates request data for a connection request from the caller communication terminal to a selected trusted contact communication terminal.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

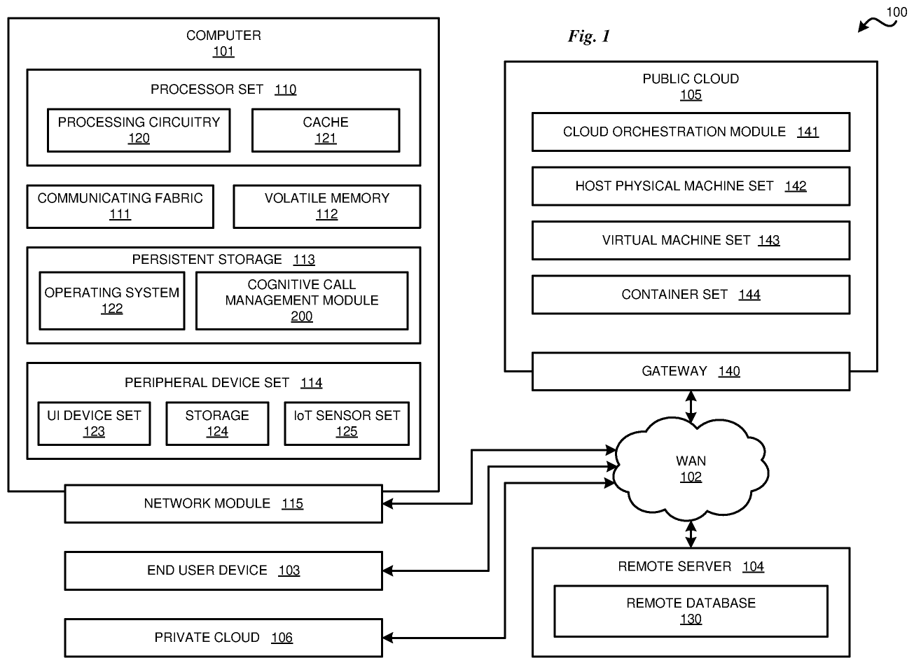

With reference to FIG. 1, this figure depicts a block diagram of a computing environment 100. Computing environment 100 contains an example of an environment for the execution of at least some of the computer code involved in performing the inventive methods, such as an improved cognitive call management module 200 that performs holistic evaluation of vulnerabilities in a vulnerability chain. In addition to cognitive call management module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and cognitive call management module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in cognitive call management module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in cognitive call management module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

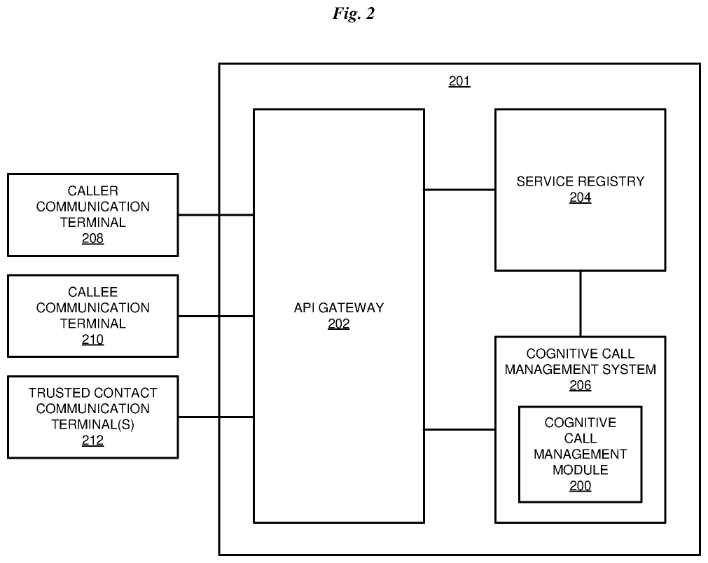

With reference to FIG. 2, this figure depicts a block diagram of an example service infrastructure 201 in accordance with an illustrative embodiment. In the illustrated embodiment, the service infrastructure 201 includes a cognitive call management system 206. In an embodiment, the cognitive call management system 206 is an example of the computer 101 of FIG. 1 and includes the cognitive call management module 200 of FIG. 1.

In the illustrated embodiment, the service infrastructure 201 provides services and service instances to user communication terminals, for example caller communication terminal 208, callee communication terminal 210, and one or more trusted contact communication terminal(s) 212. The user communication terminals communicate with service infrastructure 201 via an API gateway 202. In various embodiments, service infrastructure 201 and its associated cognitive call management system 206 serve multiple users and multiple tenants. A tenant is a group of users (e.g., a company) who share a common access with specific privileges to the software instance. Service infrastructure 201 ensures that tenant specific data is isolated from other tenants.

In the illustrated embodiment, service infrastructure 201 includes a service registry 204. In some embodiments, the cognitive call management system 206 is a virtual machine and the service registry 204 looks up service instances of cognitive call management system 206 in response to a service lookup request such as one from API gateway 202 in response to a service request (e.g., a communication attempt from caller communication terminal 208 to callee communication terminal 210 or one of the trusted contact communication terminal(s) 212).

In some embodiments, service registry 204 maintains information about the status or health of each service instance including performance information associated each of the service instances. In some such embodiments, such information may include various types of performance characteristics of a given service instance (e.g., cache metrics, etc.) and records of updates.

In some embodiments, user communication terminals connect with API gateway 202 via any suitable network or combination of networks such as the Internet, cellular networks, public switched telephone network, etc. and uses any suitable communication protocols such as Wi-Fi, Bluetooth, etc. Service infrastructure 201 may be built on the basis of cloud computing. API gateway 202 provides access to client applications like the cognitive call management module 200. API gateway 202 receives service requests issued by client applications and creates service lookup requests based on service requests. As a non-limiting example, in an embodiment, the caller communication terminal 208 executes a routine to initiate interaction with the cognitive call management module 200. For instance, in some embodiments, the user accesses the cognitive call management module 200 directly using a command line or GUI. Also, in some embodiments, the user accesses the cognitive call management module 200 indirectly through the use of an application that interacts with the cognitive call management module 200 via the API gateway 202.

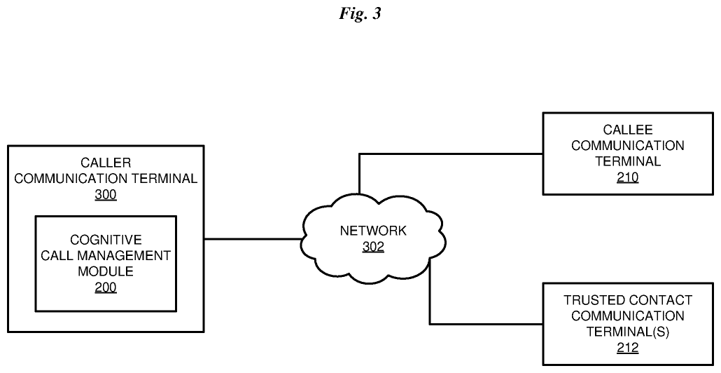

With reference to FIG. 3, this figure depicts a block diagram of an example caller communication terminal 300 in accordance with another illustrative embodiment. In the illustrated embodiment, the caller communication terminal 300 hosts the cognitive call management module 200. Thus, in the embodiment shown in FIG. 3, the cognitive call management module 200 processes service requests (e.g., a communication attempt from caller communication terminal 300 to callee communication terminal 210 or one of the trusted contact communication terminal(s) 212). In another embodiment, the cognitive call management module 200 includes submodules that are distributed among the caller communication terminal 300 and one or more servers connected to the caller communication terminal 300 via the network 302. In such embodiments, the processing of services requests is divided between the caller communication terminal 300 and one or more servers.

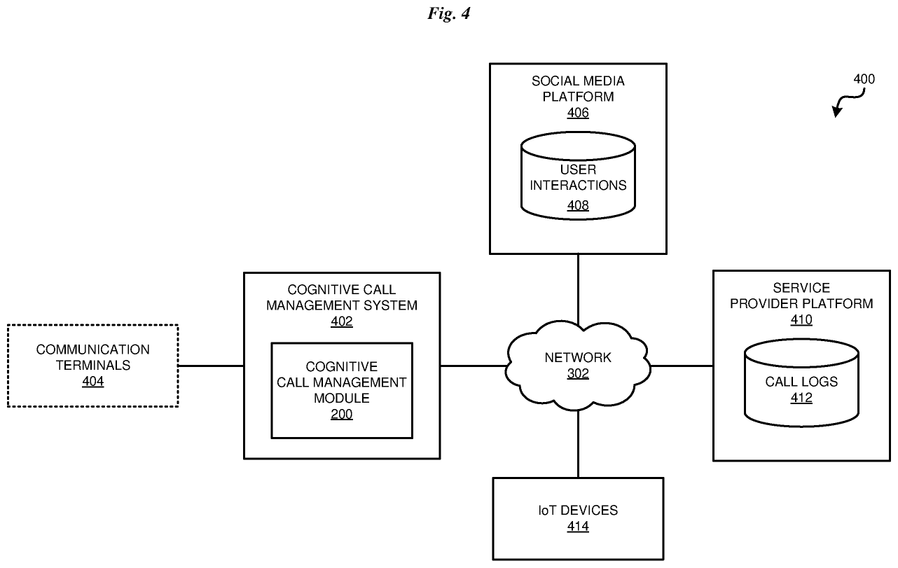

With reference to FIG. 4, this figure depicts a block diagram of an example processing environment 400 in accordance with an illustrative embodiment. In the illustrated embodiment, the caller, callee, and one or more trusted contact communication terminals (e.g., caller communication terminal 208, callee communication terminal 210, and trusted contact communication terminal(s) 212 of FIG. 2) are collectively shown as communication terminals 404.

In the illustrated embodiment, the cognitive call management module 200 is hosted on a cognitive call management system 402. In some embodiments, the cognitive call management system 402 may be a private server, for example where the communication terminals 404 are connected to the cognitive call management system 402 via a private intranet. In some embodiments, the cognitive call management system 402 may be a public server, for example that is accessible from the communication terminals 404 via the Internet.

In the illustrated embodiment, the cognitive call management module 200 allows a user to authorize the cognitive call management module 200 to monitor communication attempts from one or more of the communication terminals 404 (e.g., from the caller communication terminal 208 of FIG. 2) associated with the user. The cognitive call management module 200 then monitors communication attempts from the authorized communication terminals 404. Upon detecting a communication attempt from the caller's communication terminal, the cognitive call management module 200 then generates request data that the cognitive call management module 200 then forwards to a target (i.e., callee) communication terminal.

In the illustrated embodiment, the cognitive call management module 200 includes context data that is related to the callers with the request data. The context data includes information gathered by the cognitive call management module 200 from available and authorized resources that may be useful to a callee. For example, in some embodiments, the cognitive call management module 200 allows a user to authorize the cognitive call management module 200 to access one or more social media platforms 406, one or more service provider platforms 410, and/or one or more IoT devices 414 associated with the caller. The cognitive call management module 200 may use information from these or other available and authorized resources to generate context data that may be helpful to a callee for such things as determining the purpose of the call, the level of importance or urgency of the call, the legitimacy of the call or caller, and may include information that indicates a location of the caller, an activity of the caller, and may validate an identity of the caller or corroborate a reason for the call.

If the callee is unavailable or otherwise does not accept a call, the cognitive call management module 200 selects a third party who may be able to pass along a message to the callee or inform the callee that the caller is urgently trying to contact them. The cognitive call management module 200 selects the third party based on a trust factor and a probability factor. In some embodiments, the trust factor is established over time as the cognitive call management module 200 monitors may use information gathered from available and authorized resources that may be useful to select a third party to try to contact in order to try to reach the callee. For example, in some embodiments, the cognitive call management module 200 also allows the callee to authorize the cognitive call management module 200 to access one or more social media platforms 406, one or more service provider platforms 410, and/or one or more IoT devices 414 associated with the callee, including information shared with IoT devices 414 of third parties that share information with the callee in a social IoT network. The cognitive call management module 200 may use information from these or other available and authorized resources to generate context data about the callee that the cognitive call management module 200 may use to select a trusted contact of the callee, and then forward the call or a message to the trusted contact.

In some embodiments, the cognitive call management module 200 selects a trusted contact from a list of trusted contacts that is automatically generated by the cognitive call management module 200. In some embodiments, the cognitive call management module 200 may use information gathered from available and authorized resources that may be useful to identify a list of third parties as trusted contacts to try to contact in order to try to reach the callee when the callee cannot be reached directly by a callee. For example, in some embodiments, the cognitive call management module 200 also allows the callee to authorize the cognitive call management module 200 to access one or more social media platforms 406, one or more service provider platforms 410, and/or one or more IoT devices 414 associated with the callee for the purpose of automatically generating a list of trusted contacts. The cognitive call management module 200 may use information from these or other available and authorized resources to generate and periodically update a list of trusted contacts associated with the callee.

In an exemplary non-limiting scenario, a caller may be trying to call the callee regarding an urgent situation, but the callee may not have their phone, or their phone's battery may be completely discharged, or the callee may be distracted not notice the incoming call. When the call attempt is unsuccessful, the cognitive call management module 200 can collect information from resources as previously authorized by the callee and use the information to generate context data regarding the callee. The cognitive call management module 200 may then use the callee context data to select a trusted contact associated with the callee, and then re-route or forward the call or a message to the selected trusted contact.

For example, in some embodiments, the cognitive call management module 200 allows a user to authorize the cognitive call management module 200 to access one or more IoT devices 414 associated with the user. In such embodiments, the cognitive call management module 200 retrieves IoT data from the IoT devices 414 authorized by the user and uses the IoT data to generate the context data for the user as a caller or callee. In some embodiments, one or more of the user's IoT devices and one or more other users' IoT devices may interact in a controlled social IoT network, based on bilateral agreements from owners of the IoT devices. In some embodiments, one or more user IoT devices and one or more users' IoT devices may be permitted, for example based on confidentiality agreements, to share information about the owner's location, location history, and/or activities with the other owner's IoT devices. In some such embodiments, the cognitive call management module 200 gathers information from the information shared among the IoT devices in the social IoT network and uses relevant portions of the shared IoT data to generate the context data for the user as a caller or callee.

In some embodiments, the cognitive call management module 200 allows a user to authorize the cognitive call management module 200 to access a service provider platform 410, such as a web-based platform associated with a user's cellular telephone service. In some such embodiments, the user authorizes the cognitive call management module 200 to access call logs 412 that the cognitive call management module 200 can then process to extract call data representative of past calls or other interaction history data indicative of past interactions between the user and a caller or callee.

In some embodiments, the cognitive call management module 200 allows a user to authorize the cognitive call management module 200 to access a social media platform 406, such as a web-based social media service utilized by the user. In some such embodiments, the user authorizes the cognitive call management module 200 to access historical user interactions data 408 that the cognitive call management module 200 can then process to extract social media interaction data representative of past interactions between the user and a caller or callee.

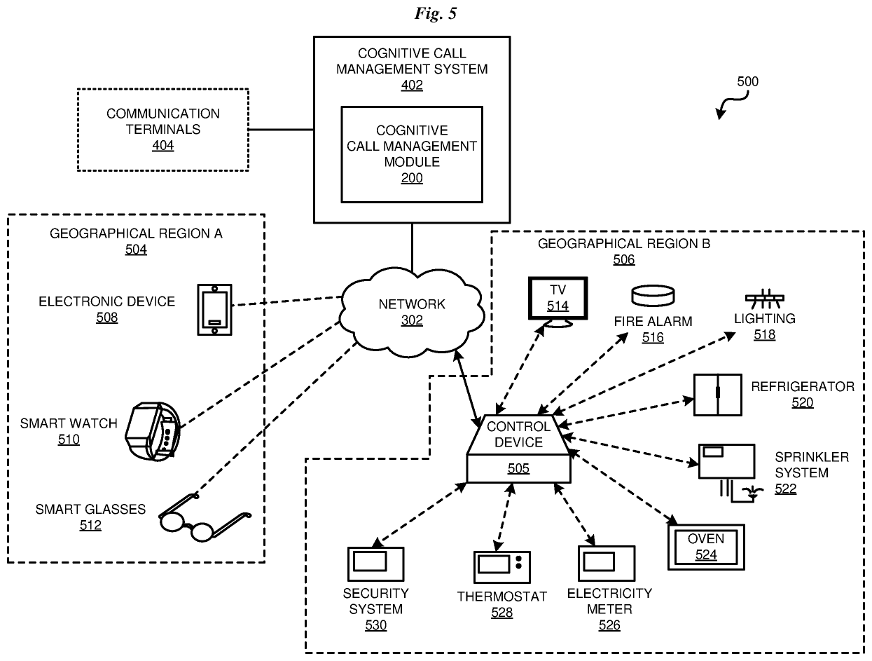

With reference to FIG. 5, this figure depicts a block diagram of an example processing environment 500 in accordance with an illustrative embodiment. In the illustrated embodiment, the caller, callee, and one or more trusted contact communication terminals (e.g., caller communication terminal 208, callee communication terminal 210, and trusted contact communication terminal(s) 212 of FIG. 2) are collectively shown as communication terminals 404.

In the illustrated embodiment, the cognitive call management module 200 is hosted on a cognitive call management system 402. In some embodiments, the cognitive call management system 402 may be a private server, for example where the communication terminals 504 are connected to the cognitive call management system 402 via a private intranet. In some embodiments, the cognitive call management system 402 may be a public server, for example that is accessible from the communication terminals 504 via the Internet.

As discussed in connection with FIG. 4, in some embodiments, the cognitive call management module 200 allows a user to authorize the caller communication terminal cognitive call management module 200 to access one or more IoT devices associated with the user. In such embodiments, the cognitive call management module 200 retrieves IoT data from the IoT devices 414, including information shared among the IoT devices 414 in a social IoT network, and uses the IoT data to generate context data that may be useful to a callee. For example, the IoT data may reveal information that the cognitive call management module 200 can use to generate context data, such as a location of the caller, an activity of the caller, or that helps validate an identity of the caller or helps corroborate the caller's reason calling.

In the illustrated embodiment, the cognitive call management module 200 may be connected to one or more of a caller's IoT devices 508 to 530 via a control device 505. in the illustrated embodiment, the caller has a first group of IoT devices 508 to 512 located in a geographic region A 504, and a second group of IoT devices 514 to 530 located in a geographic region B 506. For example, the caller may be away from home at some location within geographic region A 504 and is currently carrying or wearing the electronic device 508, smart watch 510, and smart glasses 512. At the same time, the second group of IoT devices, which include a television 514, fire alarm 516, lighting 518, refrigerator 520, sprinkler system 522, oven 524, electricity meter 526, thermostat 528, and security system 530, which are all in communication with the central control device 505, are at the caller's home.

The cognitive call management module 200 is in communication with the control device 505 via a network 302, such as the Internet. The cognitive call management module 200 may access IoT data from one or more of the IoT devices 514 to 530 from the control device 505. Alternatively, the cognitive call management module 200 may access IoT data from the IoT devices 514 to 530 themselves via the control device 505. The cognitive call management module 200 may also be in communication with others of the caller's IoT devices 508 to 512 directly via the network 302 while the IoT devices 508 to 512 are geographically distant from the control device 505. Alternatively, the cognitive call management module 200 may access IoT data from the IoT devices 508 to 512 via the control device 505. For example, in some embodiments, the control device 505 accesses IoT data from the IoT devices 508 to 512 via the network 302 and relays the IoT data to the cognitive call management module 200 via the network 302.

In the illustrated embodiment, IoT data from one or more of the IoT devices 508 to 512, including information shared among the IoT devices 508 to 512 in a social IoT network, may be used by the cognitive call management module 200 to verify a location from which the caller is attempting to call a callee. The cognitive call management module 200 may use this information as context data that is provided to the callee, which may be helpful to the callee in determining whether to accept the call. For example, in an urgent situation, the caller may be calling the callee while the callee is at work and engaged in a conference call or meeting. As a non-limiting example, in one exemplary scenario, the cognitive call management module 200 can provide context data with the call request data where the context data indicates that the caller is calling from a hospital based on location data from one or more of the IoT devices 508 to 512, and can provide additional context data indicating that the caller has an abnormal heart beat, blood pressure, glucose level, or other medical issue based on biometric data from one or more of IoT devices 508 to 512. This context data provided automatically with the call request helps the callee to verify and understand the urgent nature of the call. This allows the callee to recognize the true reason and importance of the call and make an informed decision about whether to interrupt their current work activity to take the call.

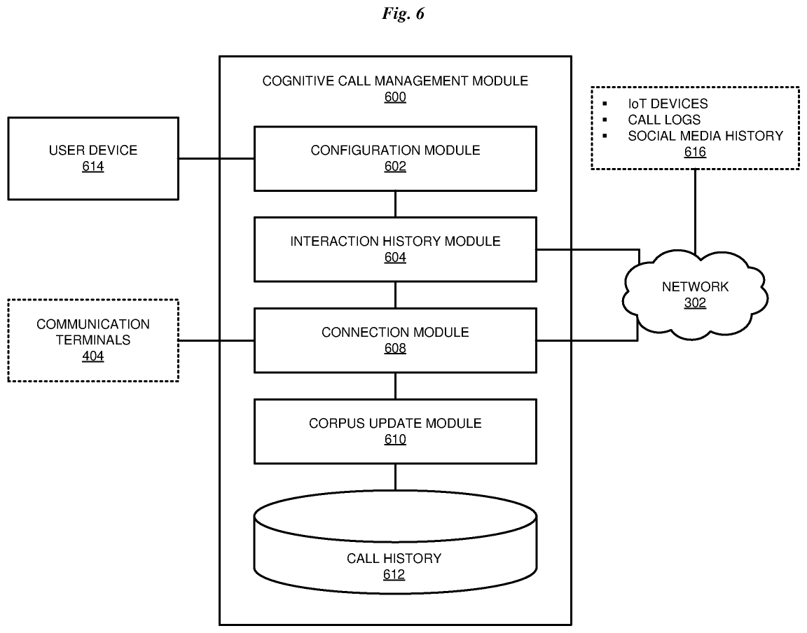

With reference to FIG. 6, this figure depicts a block diagram of an example cognitive call management module 600 in accordance with an illustrative embodiment. In a particular embodiment, the call management module 600 is an example of the cognitive call management module 200 of FIGS. 1-5.

In some embodiments, the cognitive call management module 600 includes a configuration module 602, interaction history module 604, a connection module 608, a corpus update module 610, and a call history 612. In alternative embodiments, the cognitive call management module 600 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the configuration module 602 provides an interface for communicating with a user device 614. In some embodiments, the configuration module 602 allows a user to authorize the cognitive call management module 600 to monitor communication attempts from one or more of the communication terminals 404 (e.g., from the caller communication terminal 208 of FIG. 2) associated with the user. In some embodiments, the configuration module 602 allows a user to authorize the cognitive call management module 600 to access one or more social media platforms, one or more service provider platforms, and/or one or more IoT devices (collectively shown as resources 616 in FIG. 6) associated with the user as a caller or callee. In some embodiments, the configuration module 602 allows the user to authorize the cognitive call management module 600 to access one or more social media platforms, one or more service provider platforms, and/or one or more IoT devices that may be included in available and authorized resources 616 associated with the user for the purpose of automatically generating and periodically updating a list of trusted contacts.

In the illustrated embodiment, the interaction history module 604 extracts call details, social interaction details, social IoT interaction details for a user (e.g., as a caller) and derives a relationship between the user (as a caller) and a callee. If the callee is unavailable or otherwise does not accept a call, the interaction history module 604 collects, via network 302, and extracts information gathered from available and authorized resources 616 that may be useful to select a third party to try to contact in order to try to reach the callee. For example, in some embodiments, the interaction history module 604 extracts information one or more social media platforms, one or more service provider platforms, and/or one or more IoT devices that may be included in available and authorized resources 616 associated with the callee.

In the illustrated embodiment, the connection module 608 monitors the communication terminals 404 and detects communication attempts, such as a call being attempted from a caller to a callee. The connection module 608, upon detecting the communication attempt, generates request data indicative of the connection request from a caller communication terminal associated with the caller to a callee communication terminal associated with a callee. The connection module 608 also appends caller context data generated by the interaction history module 604 to the request data.

In some embodiments, the connection module 608 monitors the connection attempt. If the connection module 608 detects a connection failure resulting from the connection request, the connection module 608 may attempt to select a trusted contact, and then forward the call or a message from the caller to the selected trusted contact. In some such embodiments, the interaction history module 604 generates callee context data based at least in part on the information that the interaction history module 604 extracted from one or more social media platforms, one or more service provider platforms, and/or one or more IoT devices that may be included in available and authorized resources 616 associated with the callee. The connection module 608 may use information from these or other available and authorized resources to generate context data about the callee that the cognitive connection module 608 may use to select a trusted contact of the callee, and then forward the call or a message to the trusted contact. In some embodiments, the connection module 608 may mask or encrypt some or all of the request and context data before sending the request data with appended context data to the selected trusted contact.

In the illustrated embodiment, the corpus update module 610 maintains data that a historic corpus of caller to callee interactions in a call history 612. In some embodiments, the call history 612 includes records of call attempts from the caller to the callee. In some embodiments, the call history 612 may further include additional call history data, such as data indicating number of call attempts, number or percentage of successful call attempts, context data used with each of the call attempts, time and/or location of caller and/or callee for each of the call attempts, and any other related information that may be used to predict call success for future connection attempts.

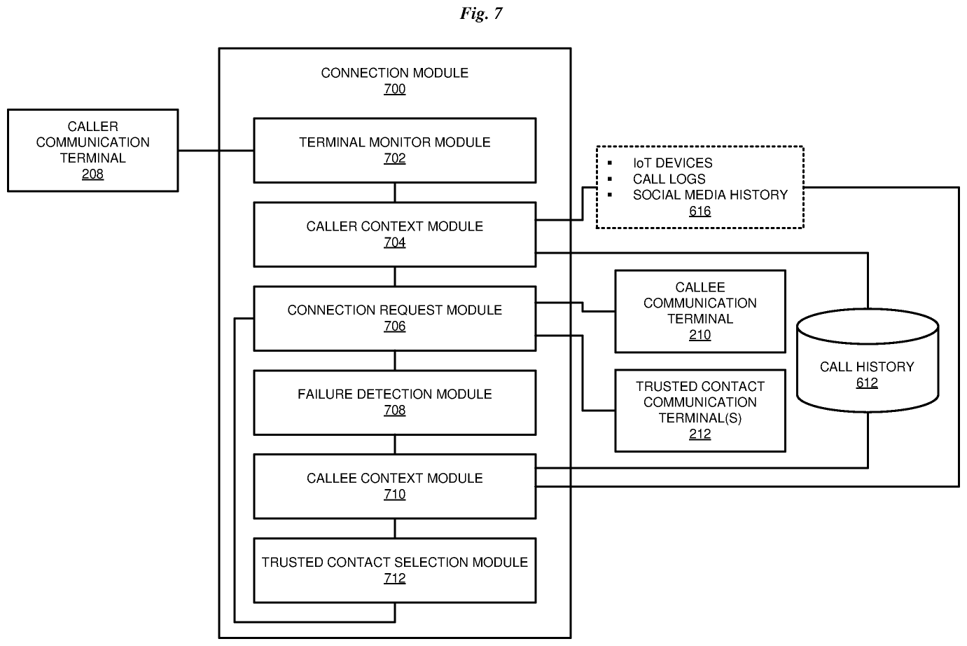

With reference to FIG. 7, this figure depicts a block diagram of an example connection module 700 in accordance with an illustrative embodiment. In a particular embodiment, the connection module 700 is an example of the connection module 608 that includes at least some of the functionality of the interaction history module 604 of FIG. 6.

In some embodiments, the connection module 700 includes terminal monitor module 702, a caller context module 704, a connection request module 706, a failure detection module 708, a callee context module 710, and a trusted contact selection module 712. In alternative embodiments, the connection module 700 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the terminal monitor module 702 monitors communication attempts from the caller communication terminal 208. In some embodiments, the communication attempts may include attempts to place a telephone call and/or attempts to send a message, such as a Short Messaging Service (SMS) or Multimedia Messaging Service (MMS) message.

Upon detecting a communication attempt from the caller's communication terminal 208, terminal monitor module 702 generates request data to forward to a callee communication terminal 210. The terminal monitor module 702 also notifies the caller context module 704 of the communication attempt from the caller communication terminal 208.

In the illustrated embodiment, the caller context module 704 generates context data that is related to the callee that will be appended to the request data. In some embodiments, the context data includes information gathered from available and authorized resources 616 that may be useful to a callee. In some embodiments, the caller context module 704 may also use data from the historic corpus of caller to callee interactions in the call history 612 for generating the context data. For example, the caller context module 704 may use information from these or other available and authorized resources to generate context data that may be helpful to a callee for such things as determining the purpose of the call, the level of importance or urgency of the call, the legitimacy of the call or caller, and may include information that indicates a location of the caller, an activity of the caller, and may validate an identity of the caller or corroborate a reason for the call.

In the illustrated embodiment, the caller context module 704 appends the context data to the request data and provides this data to the connection request module 706. The connection request module 706 then transmits the request data as a communication request to the callee communication terminal 210. The connection request module 706 then notifies the failure detection module 708 of the pending communication request so that the failure detection module 708 can monitor the communication request. In some embodiments, the failure detection module 708 detects if the communication request fails and notifies the callee context module 710.

In the illustrated embodiment, the callee context module 710 attempts to generate context data about the callee that can be used to help select a trusted contact of the callee. In some such embodiments, the callee context module 710 generates callee context data based at least in part on the information that the callee context module 710 extracts from one or more social media platforms, one or more service provider platforms, and/or one or more IoT devices that may be included in available and authorized resources 616 associated with the callee. In some embodiments, the callee context module 710 may also use data from the historic corpus of caller to callee interactions in the call history 612 for generating the context data. The callee context module 710 may use information from these or other available and authorized resources to generate context data about the callee.

In the illustrated embodiment, the callee context module 710 provides the callee context data to the trusted contact selection module 712. The trusted contact selection module 712 uses the callee context data to select a third party to try to contact in order to try to reach the callee. In some embodiments, the trusted contact selection module 712 selects a trusted contact from a list of trusted contacts that is automatically generated by the cognitive call management module (e.g., the cognitive call management module 200). In some embodiments, the trusted contact selection module 712 may use information gathered from available and authorized resources that may be useful to identify a list of third parties as trusted contacts to try to contact in order to try to reach the callee when the callee cannot be reached directly by a callee.

In an exemplary non-limiting scenario, a caller may be trying to call the callee regarding an urgent situation, but the callee may not have their phone, or their phone's battery may be completely discharged, or the callee may be distracted not notice the incoming call. When the call attempt is unsuccessful, the callee context module 710 can collect information from resources as previously authorized by the callee and then the callee context module 710 uses the information to generate context data regarding the callee. The trusted contact selection module 712 then uses the callee context data to select a trusted contact associated with the callee. The trusted contact selection module 712 the notifies the connection request module 706 of the new connection target being the selected trusted contact.

The connection request module 706 then forwards or re-routes the call or a message to the selected one of the trusted contact communication terminal(s) 212. In some embodiments, the connection request module 706 may mask or encrypt some or all of the request and context data before sending the request data with appended context data to the selected trusted contact.

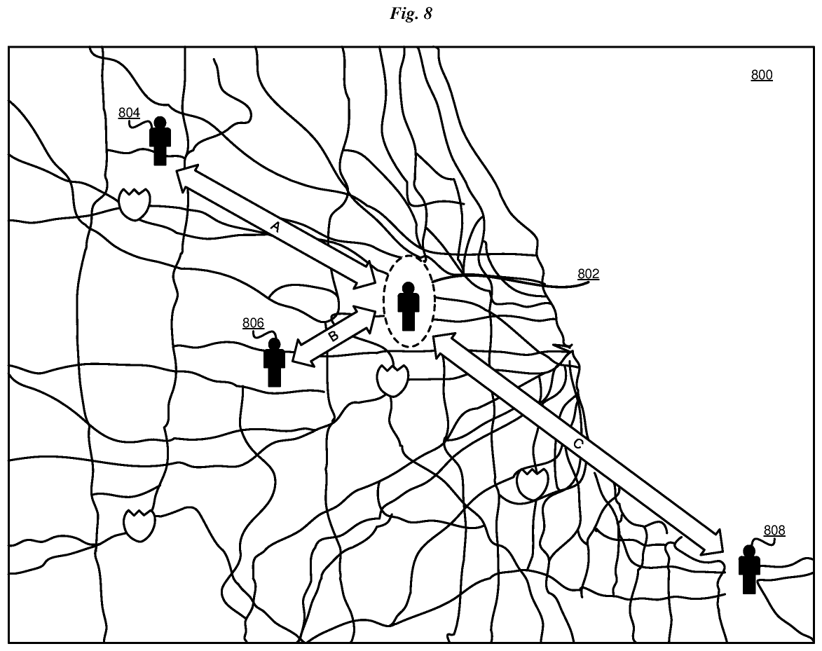

With reference to FIG. 8, this figure depicts a schematic diagram of an example of a map 800 used to select a trusted contact in accordance with an illustrative embodiment. In an embodiment, the map 800 is generated by the callee context module 710 of FIG. 7 and then used by the trusted contact selection module 712 of FIG. 7 to select a trusted contact.

The map 800 shows a geographic location of a callee 802 that a caller was unable to reach with a connection request. The map 800 also shows geographic locations of a plurality of trusted contacts 804 to 808. In some embodiments, the callee 802 and trusted contacts 804 to 808 have previously authorized a cognitive call management module to access one or more social media platforms, one or more service provider platforms, and/or one or more IoT devices. In the illustrated embodiment, the cognitive call management module has accessed such information to extract the geographic locations of the trusted contacts 804 to 808 on the map 800. In an exemplary scenario, the caller and/or callee have previously indicated a preference for the cognitive call management module to select a trusted contact that is geographically closest to the callee. Thus, the cognitive call management module 200 determines distances between the trusted contacts 804 to 808 and the callee 802. As shown in FIG. 8, in this example, the arrow A indicates a first distance between the callee 802 and the trusted contact 804; the arrow B indicates a second distance between the callee 802 and the trusted contact 806; and the arrow C indicates a third distance between the callee 802 and the trusted contact 808. Since the trusted contact 806 is the closest to the callee 802, the trusted contact 806 is selected.

It will be appreciated that in actual implementations there may be more or fewer than three trusted contacts from which to select. Also, in actual implementations, the cognitive call management module may calculate the geographic distances based on Global Positioning Satellite (GPS) coordinates without rendering a map such as map 800. Also, the geographic region within which the cognitive call management module locates the trusted contacts may be larger or smaller than what is shown as the map 800. For example, in some embodiments, the geographic region may be within an office building, shopping mall, hospital, or other facility. Alternatively, the geographic region may span several cities, states, countries, continents, or other regions.

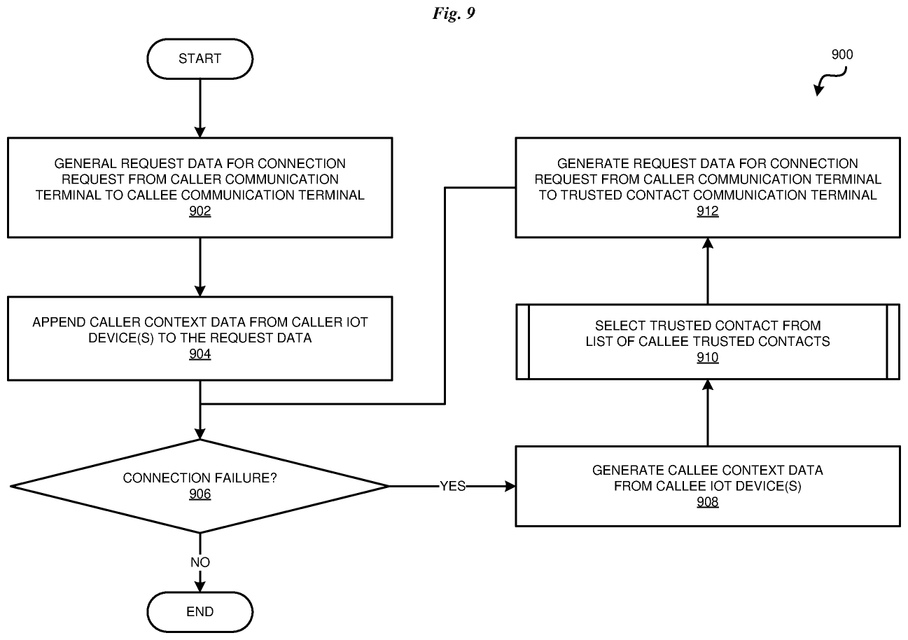

With reference to FIG. 9, this figure depicts a flowchart of an example process 900 for automatic cognitive selection of a trusted contact using IoT data in accordance with an illustrative embodiment. In a particular embodiment, the cognitive call management module 200 of FIGS. 1 to 5, cognitive call management module 600 of FIG. 6, or connection module 700 of FIG. 7 carries out the process 900.

At block 902, the process generates request data for a connection request from caller communication terminal to a callee communication terminal. In some embodiments, the process includes monitoring communication attempts from a communication terminal, and upon detecting a communication attempt from the communication terminal, the process generates request data that the process then forwards to a target (i.e., callee) communication terminal.

Next, at block 904, the process appends caller context data from caller IoT device(s) to the request data. In some embodiments, the process includes gathering context data from available and authorized resources that may be useful to a callee. For example, in some embodiments, the process includes gathering information from one or more social media platforms associated with the caller, one or more service provider platforms associated with the caller, and/or one or more IoT devices associated with the caller. In such embodiments, the process may include using information from these or other available and authorized resources to generate context data that may be helpful to a callee for such things as determining the purpose of the call, the level of importance or urgency of the call, the legitimacy of the call or caller, and may include information that indicates a location of the caller, an activity of the caller, and may validate an identity of the caller or corroborate a reason for the call.

Next, at block 906, the process determines if the connection failed. If not, the process ends. If so, the process continues to block 908.

At block 908, the process generates callee context data from callee IoT device(s). In some embodiments, the process uses the callee context data, at block 910, to select a trusted contact from list of the callee's trusted contacts. For example, in some embodiments, if the callee is unavailable or otherwise does not accept a call, the process selects a third party who may be able to pass along a message to the callee or inform the callee that the caller is urgently trying to contact them.

In some embodiments, the process selects the third party based on a trust factor and a probability factor. In some embodiments, the trust factor is established over time as the process monitors use information gathered from available and authorized resources that may be useful to select a third party to try to contact in order to try to reach the callee. For example, in some embodiments, the process allows the callee to authorize access to one or more social media platforms associated with the callee, one or more service provider platforms associated with the callee, and/or one or more IoT devices associated with the callee.

In some embodiments, the process may use information from these or other available and authorized resources to generate context data about the callee that the process may use to select a trusted contact of the callee. In some embodiments, the process then forwards the call or a message to the trusted contact. For example, as shown at block 912, in some embodiments, the process generates request data for a connection request from the caller communication terminal to a selected trusted contact communication terminal.

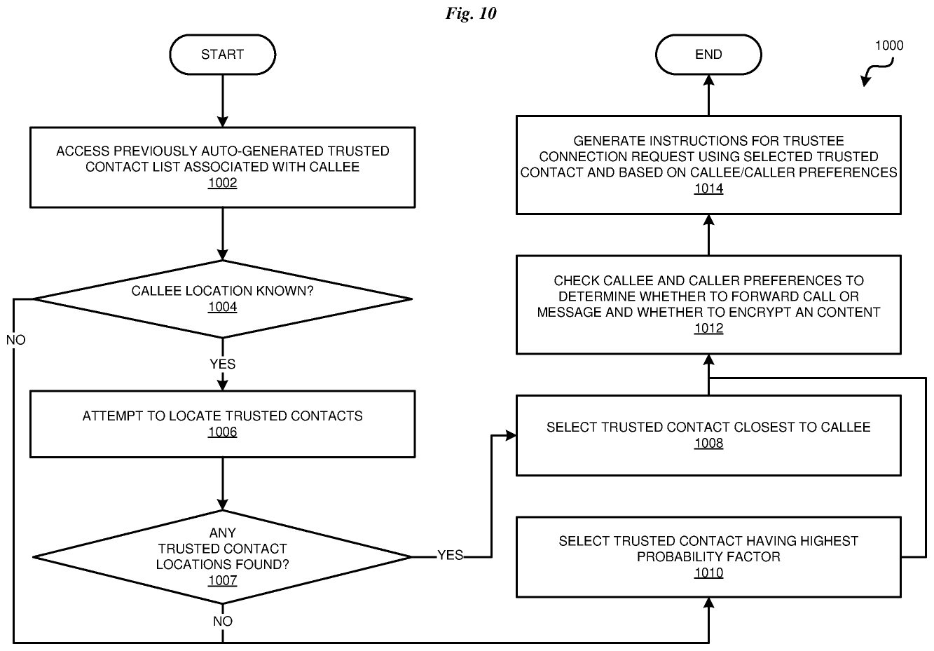

With reference to FIG. 10, this figure depicts a flowchart of an example process 1000 for automatically selecting a trusted contact in accordance with an illustrative embodiment. In a particular embodiment, the process 1000 is an example of block 910 of FIG. 9.

At block 1002, the process accesses a previously auto-generated trusted contact list associated with callee. In some embodiments, the process includes generating the list of trusted contacts based at least in part on interaction history data indicative of past interactions between the callee and each of the trusted contacts. In some embodiments, the process includes receiving authorization to access one or more social media platforms, one or more service provider platforms, and/or one or more IoT devices that may be included in available and authorized resources associated with a callee for the purpose of automatically generating and periodically updating a list of trusted contacts. In some such embodiments, the process uses information gathered from available and authorized resources that may be useful to identify a list of third parties as trusted contacts to try to contact in order to try to reach the callee when the callee cannot be reached directly by a callee.

For example, in some embodiments, the process allows a user to authorize the process to access a service provider platform, such as a web-based platform associated with a user's cellular telephone service. In some such embodiments, the user authorizes the process to access call logs that the process can then analyze to extract call data representative of past calls or other interaction history data indicative of past interactions between the user and a caller or callee.

In some embodiments, the process allows a user to authorize the process to access a social media platform, such as a web-based social media service utilized by the user. In some such embodiments, the user authorizes the process to access historical user interactions data that the process can then analyze to extract social media interaction data representative of past interactions between the user and a caller or callee.

Next, at block 1004, the process determines whether the callee's location is known or can be ascertained from available information. If so, the process continues to block 1006; if not, the process continues to block 1010.

Next, at block 1006, the process attempts to locate one or more trusted contacts of the callee. In some embodiments, the process allows a user to authorize the process to access one or more social media platforms, one or more service provider platforms, and/or one or more IoT devices associated with the user as a callee and/or as a trusted contact. The process may use information from these or other available and authorized resources to generate context data that may be helpful for determining a current location of a callee at block 1004 or trusted contact at block 1006.

Next, at block 1007, the process determines whether any trusted contacts' locations are known or can be ascertained from available information. If so, the process continues to block 1008; if not, the process continues to block 1010.

At block 1008, since the location of the callee and at least one trusted contact is known, the process selects the trusted contact that is geographically closest to callee. For example, in some embodiments, the process determines distances between the trusted contacts and the callee and selects the trusted contact that is geographically closest to the callee. In some embodiments, the process may calculate the geographic distances based on Global Positioning Satellite (GPS) coordinates of the respective locations of the trusted contacts and callee.

Alternatively, at block 1010, since the location of the callee and at least one trusted contact is not known, the process selects a trusted contact having a highest probability factor. In some embodiments, the trust factor is established over time as the process monitors use information gathered from available and authorized resources that may be useful to select a third party to try to contact in order to try to reach the callee. For example, in some embodiments, the process allows the callee to authorize access to one or more social media platforms associated with the callee, one or more service provider platforms associated with the callee, and/or one or more IoT devices associated with the callee.

Next, at block 1012, the process checks callee and caller preferences to determine whether to forward the call or forward a message and determines whether to encrypt any forwarded content. Next, at block 1014, the process generates instructions for a trustee connection request using the selected trusted contact and complying with callee/caller preferences.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating, responsive to detecting a communication attempt made by a caller, first request data indicative of a first connection request from a caller communication terminal associated with the caller to a callee communication terminal associated with a callee;
appending caller context data to the first request data, wherein the caller context data is based at least in part on first Internet of Things (IoT) data received from a first IoT device associated with the caller;
detecting a first connection failure resulting from the first connection request;
generating callee context data based at least in part on second IoT data received from a second IoT device associated with the callee;
selecting, responsive to detecting the first connection failure, a first trusted contact from among a list of trusted contacts associated with the callee, wherein the first trusted contact is selected based at least in part on the callee context data; and
generating second request data indicative of a second connection request from the caller communication terminal associated with the caller to a contact communication terminal associated with the first trusted contact.

2. The computer-implemented method of claim 1, further comprising:
generating interaction history data indicative of past interactions between the caller and the callee,
wherein the callee context data is further based at least in part on the interaction history data.

3. The computer-implemented method of claim 2, wherein the generating of the interaction history data comprises extracting, from a call log associated with the caller, call data representative of past calls between the caller and the callee.

4. The computer-implemented method of claim 2, wherein the generating of the interaction history data comprises extracting, from a social media account associated with the caller, social media data representative of past social media communications between the caller and the callee.

5. The computer-implemented method of claim 1, wherein the first connection request comprises a reason for the call, and wherein the caller context data comprises information that validates the reason for the call.

6. The computer-implemented method of claim 5, wherein the first connection request comprises an indication of an urgent reason for the call, and wherein the caller context data comprises information that validates the urgent reason for the call.

7. The computer-implemented method of claim 6, wherein the first IoT data comprises at least one of biomedical data and geographical location data.

8. The computer-implemented method of claim 5, wherein the second connection request masks at least a portion of the reason for the call.

9. The computer-implemented method of claim 1, further comprising:
generating the list of trusted contacts based at least in part on interaction history data indicative of past interactions between the callee and each of the trusted contacts.

10. The computer-implemented method of claim 9, wherein the generating of the list of trusted contacts comprises extracting, from a call log associated with the callee, call data representative of past calls between the callee and each of the trusted contacts.

11. The computer-implemented method of claim 9, wherein the generating of the list of trusted contacts comprises extracting, from a social media account associated with the callee, social media data representative of past social media communications between the callee and each of the trusted contacts.

12. The computer-implemented method of claim 1, further comprising:
detecting a second connection failure resulting from the second connection request; and
selecting, responsive to detecting the second connection failure, a second trusted contact from among the list of trusted contacts associated with the callee, wherein the second trusted contact is selected based at least in part on the callee context data.

13. A computer program product comprising one or more computer readable storage media, and program instructions collectively stored on the one or more computer readable storage media, the program instructions executable by a processor to cause the processor to perform operations comprising:
generating, responsive to detecting a communication attempt made by a caller, first request data indicative of a first connection request from a caller communication terminal associated with the caller to a callee communication terminal associated with a callee;
appending caller context data to the first request data, wherein the caller context data is based at least in part on first Internet of Things (IoT) data received from a first IoT device associated with the caller;
detecting a first connection failure resulting from the first connection request;
generating callee context data based at least in part on second IoT data received from a second IoT device associated with the callee;
selecting, responsive to detecting the first connection failure, a first trusted contact from among a list of trusted contacts associated with the callee, wherein the first trusted contact is selected based at least in part on the callee context data; and
generating second request data indicative of a second connection request from the caller communication terminal associated with the caller to a contact communication terminal associated with the first trusted contact.

14. The computer program product of claim 13, wherein the stored program instructions are stored in a computer readable storage device in a data processing system, and wherein the stored program instructions are transferred over a network from a remote data processing system.

15. The computer program product of claim 13, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

16. The computer program product of claim 13, wherein the operations further comprise:
generating interaction history data indicative of past interactions between the caller and the callee,
wherein the callee context data is further based at least in part on the interaction history data.

17. The computer program product of claim 13, wherein the operations further comprise:
generating the list of trusted contacts based at least in part on interaction history data indicative of past interactions between the callee and each of the trusted contacts.

18. A computer system comprising a processor and one or more computer readable storage media, and program instructions collectively stored on the one or more computer readable storage media, the program instructions executable by the processor to cause the processor to perform operations comprising:
generating, responsive to detecting a communication attempt made by a caller, first request data indicative of a first connection request from a caller communication terminal associated with the caller to a callee communication terminal associated with a callee;
appending caller context data to the first request data, wherein the caller context data is based at least in part on first Internet of Things (IoT) data received from a first IoT device associated with the caller;
detecting a first connection failure resulting from the first connection request;
generating callee context data based at least in part on second IoT data received from a second IoT device associated with the callee;
selecting, responsive to detecting the first connection failure, a first trusted contact from among a list of trusted contacts associated with the callee, wherein the first trusted contact is selected based at least in part on the callee context data; and
generating second request data indicative of a second connection request from the caller communication terminal associated with the caller to a contact communication terminal associated with the first trusted contact.

19. The computer system of claim 18, wherein the operations further comprise:
generating interaction history data indicative of past interactions between the caller and the callee,
wherein the callee context data is further based at least in part on the interaction history data.

20. The computer system of claim 18, wherein the operations further comprise:
generating the list of trusted contacts based at least in part on interaction history data indicative of past interactions between the callee and each of the trusted contacts.
